(19) United States
(12) Patent Application Publication
(10) Pub. No.: US 2025/0024278 A1
(43) Pub. Date: Jan. 16, 2025

(54) RADIO DIGITAL TWIN PLATFORM OBSERVABILITY ENGINE

(71) Applicant: DISH Wireless L.L.C., Englewood, CO (US)

(72) Inventors: Mostafa Tofighbakhsh, Cupertino, CA (US); Mahdi Khansari, Littleton, CO (US); Arash Mahmoudian, Littleton, CO (US)

(21) Appl. No.: 18/750,904

(22) Filed: Jun. 21, 2024

Related U.S. Application Data
(60) Provisional application No. 63/522,389, filed on Jun. 21, 2023.

(51) Int. Cl. H04W 24/06

(52) U.S. Cl. CPC H04W 24/06

(57) ABSTRACT

A method for generating a digital twin of a radio network (RN) is disclosed that includes accessing, by one or more processing devices, a digital twin representation (DTR) of the RN, the RN including a plurality of nodes configured to enable communications between wireless user equipments (UEs), the DTR including virtual representations of the plurality of nodes and the interconnections. Using a trained machine learning (ML) model, a subset of the DTR is identified, the subset being representative of operating conditions for a particular time range. The method includes determining, by the processing devices via monitoring parameters of the subset of the DTR, that at least one of the operating conditions of the RN is outside of an expected range. In response to determining that the operating conditions of the RN is outside of the expected range, generating an output signal is generated indicative of a condition of the RN.

### CROSS-REFERENCE TO RELATED APPLICATIONS

This application claims the benefit of the filing date of U.S. Provisional Application 63/522,389, filed on Jun. 21, 2023, the entire content of which is incorporated herein by reference.

### TECHNICAL FIELD

This specification pertains to digital twins of cellular networks such as 5G Open Radio Access Networks (O-RANs).

### BACKGROUND

Cellular networks such as 5G O-RANs often include vast amount of nodes and software/hardware modules. Tracking various operating conditions and parameters of such large scale networks can be challenging.

### SUMMARY

Disclosed herein are technologies that can be leveraged to monitor operating conditions and performance parameters of a radio network environment (e.g., a 5G O-RAN cellular network) via a digital twin representation of such an environment. In one aspect, the technology described herein is embodied in a method that includes, accessing, by a one or more processing devices, a digital twin representation of a radio network (RN), the radio network including a plurality of nodes configured to enable communications between wireless user equipments (UEs), the digital twin representation including virtual representations of the plurality of nodes and the interconnections among the plurality of nodes. The method further includes identifying, using a trained machine learning model, a subset of the digital twin representation, wherein the subset is identified by the machine learning model as being representative of operating conditions of the radio network for a particular time range. The method proceeds via determining, by the one or more processing devices via monitoring one or more parameters of the subset of the digital twin representation, that at least one of the operating conditions of the radio network is outside of an expected range. In response to determining that at least one of the operating conditions of the radio network is outside of the expected range, the method continues by generating an output signal indicative of a condition of the radio network.

The details of one or more embodiments of the subject matter of this specification are set forth in the accompanying drawings and the description below. Other features, aspects, and advantages of the subject matter will become apparent from the description, the drawings, and the claims.

This document includes an appendix, the content of which is incorporated herein by reference.

### BRIEF DESCRIPTION OF THE DRAWINGS

FIG. 1 illustrates an example of a network environment 100 having a plurality of regions 102.

FIG. 2 illustrates an example of a system architecture 200 for the digital twin 108 of the network environment 100.

FIG. 3 is a flowchart of an example process 300 for implementing the digital twin 108 shown in FIGS. 1-2.

FIG. 4 illustrates an example of a computing device 400 and a mobile computing device 450

Like reference numbers and designations in the various drawings indicate like elements.

### DETAILED DESCRIPTION

The technology described herein pertains to using digital twin representations of a radio network environment (e.g., a 5G O-RAN cellular network) to efficiently track various operating conditions and performance parameters of such an environment. Digital twin representations are often used in industrial settings, for example, to track operating conditions of manufacturing plants etc. through virtual/digital representation of various portions/modules of the plants. However, a digital twin representation of large-scale wireless networks such as a 5G O-RAN cellular network include vast amounts of interconnected nodes, software/hardware modules etc., which makes analyzing the digital twin representation in its entirety computationally intensive, and potentially prohibitively time-consuming. The technology described herein espouses intelligent identification of a subset or portion of the digital twin such that the identified portion can be processed with significantly lower computational resources and latency (as compared to processing the digital twin representation it its entirety) while also reliably representing the operating conditions/parameters of the entire network. Notably, a subset/portion of the digital twin that reliably represents the conditions in the entire network can be a function of time. For example, the digital twin representation of a cell tower in a busy commercial district may well-represent the traffic condition of a network during business hours, but not at midnight. Accordingly, the identification of the subset/portion of digital twin that reliably represents the entire network may have to be updated intermittently. The technology described herein espouses using trained machine-learning (ML) models that can automatically identify, based on one or more input parameters, relevant entities from the entire digital twin representation for inclusion in the representative set. The ML models can be invoked intermittently (e.g., periodically, or based on one or more trigger conditions) to update the representative portion of the digital twin as a function of time.

In various implementations, the technology described herein can facilitate one or more of the following advantages. By intelligently identifying a tractable yet representative subset/portion of a digital twin representation of a large scale wireless network, various applications of digital twins can be leveraged to facilitate efficient functioning of the large scale network. For example, applications such as anomaly detection, root cause diagnostics, key performance indices (KPI) monitoring, RAN resource optimization etc., can be implemented for large scale wireless networks. By using appropriately trained ML models, a representative subset can be adaptively identified as a function of time, potentially proactively, such that identified subsets reliably represent the operating conditions/performance parameters of the large scale model at all times. As such, the technology described herein can potentially improve performance and efficiency of a large scale wireless network while significantly reducing costs such as computational resources and latency that would be associated with processing information from the entire digital twin representation of the network.

In some implementations, this specification discloses an architecture/platform that allows for observation/analysis of a digital twin of radio networks. In some implementations, the platform enables automatic discovery of various network components (e.g., radios, cell sites, etc.) and representing them as virtual nodes/modules in a digital twin representation of the network. The platform can be configured to track certain radio core parameters/functions such as discovery of cells, radio, topology, beams, service slices, usages, etc. In some implementations, the platform can be configured to generate control signals for controlling one or more of the corresponding network entities. In some implementations, the platform ca be configured to be scalable to represent/monitor arbitrarily large number of cell sites and radios by updating/monitoring the corresponding virtual representations in the digital twin. Such a platform may be referred to as a radio digital twin (RDT) platform. In some implementations, an RDT platform utilizes machine learning and/or artificial intelligence to identify outliers, anomalies, or other irregular network behaviors. In some implementations, the RDT platform can be configured to generate one or more control signals aimed to address the identified outlying behavior or anomaly.

In some implementations, the RDT platform provides access to multiple end users (e.g., vendors or service providers) that are able to monitor the radio network, receive predictive analytics, test updates, and provide solution directly to the digital twin prior to implementation on the network. Advantageously, the RDT platform may allow the aforementioned monitoring or updates without shutting down a network component or reducing the number of operational components on the network.

In some radio networks, terabytes of data are transmitted and received in a given day. The RDT platform is thus configured to identify representative nodes or network components that represent an overall condition of the radio network or a pre-defined area of the radio network. As such, the RDT platform enables anomaly detection by monitoring a sub-set of the radio network (e.g., 1 percent of the radio network) in the digital twin, instead of monitoring the entirety of the network for anomalies. In this manner, the RDT platform is able to reliably monitor the radio network, predict alarms, and provide recommendations in manner not previously available.

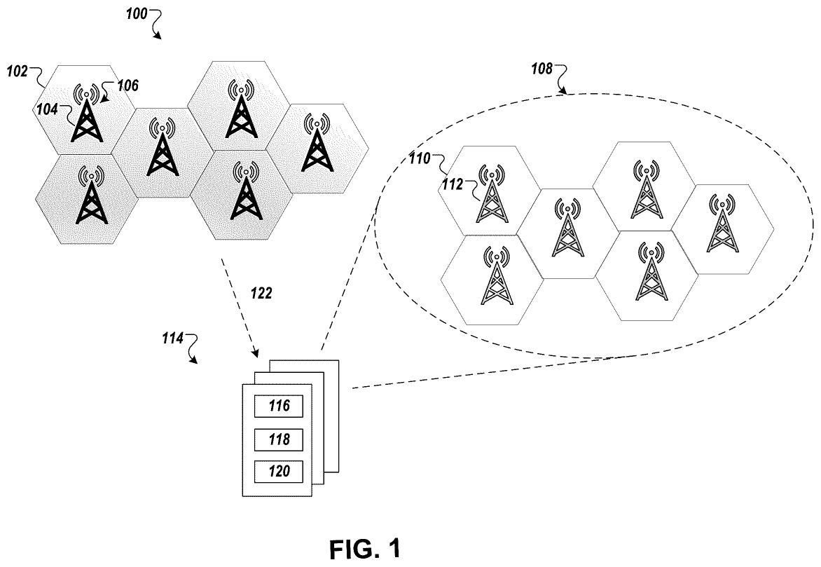

FIG. 1 shows an example of a network environment 100 having a plurality of regions 102. One or more computing devices 114 can be configured to implement the RDT platform associated with the network environment 100. For example, the one or more computing devices 114 can implement a digital twin 108 as a virtual replica of the network environment 100. As used herein, a network environment (sometimes referred to herein simply as an environment) refers to a set of multiple devices, modules, and functions that are configured to jointly provide wireless communication services. For example, a network environment 100 can include a 5G network that includes a set of multiple devices, radio access network (RAN)/core network functions, and application functions that are configured and integrated to jointly enable wireless communication. An environment, such as the environment 100, can be a portion of a 5G New Radio (“5G-NR” or simply “5G”) cellular network environment. Standards for cellular network architectures have previously been described, for example, in 3GPP TS 23.501 (for 5G networks) and 3GPP TS 23.401 (for 4G long-term evolution “LTE” networks) (the entireties of which are hereby incorporated by reference).

The network environment 100 can include a plurality of regions 102. In a cellular communication environment, the regions 102 can be referred to as cells. At least one node 104 is disposed within each region 102. In some implementations, a node 104 can be a tower servicing a particular cell. In some implementations, one or more sensors 106 can be configured to transmit information 122 (e.g., one or more parameters and/or information indicative of operating conditions of the corresponding node/region) from each node 104. For simplicity, only one sensor 106 is shown, however it is understood that multiple sensors 106 can be deployed in each region 102. In some implementations, one or more software modules can be used in place of (or in conjunction with) one or more sensors to obtain the information 122 on the operating conditions of corresponding regions/nodes. In some implementations, the information indicative of operating conditions of the corresponding node/region can be used to update the digital twin representation 108.

In some implementations, the digital twin 108 is a virtual replica of the network environment 100. For example, the digital twin 108 can represent virtual representations of various elements (and their interconnections) of the network environment 100. In some implementations, the digital twin 108 can be generated by the one or more computing devices 114, based on information received from the network environment 100, for example as collected by the one or more sensors 106. The one or more computing devices 114 can include one or more processors 116, memory 118, and other circuitry 120. In some implementations, the one or more computing devices 114 can include a server. In some implementations, the one or more computing devices includes units of a distributed computing system such as a cloud-computing system.

Digital twins can be represented in various forms. In some implementations, the regions 102 can be represented in the digital twin 108 as corresponding virtual regions 110 while the nodes 104 can be represented as corresponding virtual nodes 112. The digital twin 108 also includes virtual representations of interconnections among the plurality of nodes. In some implementations, the digital twin 108 can be configured to model the behavior and dynamics of the network environment 100. In some implementations, the digital twin 108 can include a virtual representation of the network 100 in the form of a directed graph of the various components of the network environment 100. The edges of the directed graph connect various vertices, e.g., representing nodes 104, and indicate a direction of the flow of data in the environment 100. In some implementations, the digital twin 108 includes a subset of each nodes 104 represented in the radio network 100. A current and historical state of the network environment 100 can be represented in the digital twin 108. The configuration, age, and operating environment may also be modelled in the digital twin 108.

In some implementations, the digital twin 108 can be configured to be scalable with the network 100. For example, as more nodes or other components are added to the network 100, the digital twin 108 can be updated accordingly. In some implementations, an RDT platform implemented on the one or more computing devices 114 can be configured to automatically discover new components added to the network 100. The network 100 can be an arbitrarily large network. For example, the network 100 can be part of or an entirety of a municipal, national, or international cellular grid-potentially with vast amounts of nodes and other components. For such large-scale networks, processing data from the corresponding digital twin can be extremely time consuming and resource intensive. For example, a single root cause can trigger downstream alerts across a vast number of nodes in a large scale network, and analyzing the correspondingly large volume of data from the respective digital twin may require significant computing resources. In addition, the time required to process such a large volume of data to identify the root cause may be too long to timely address the root cause.

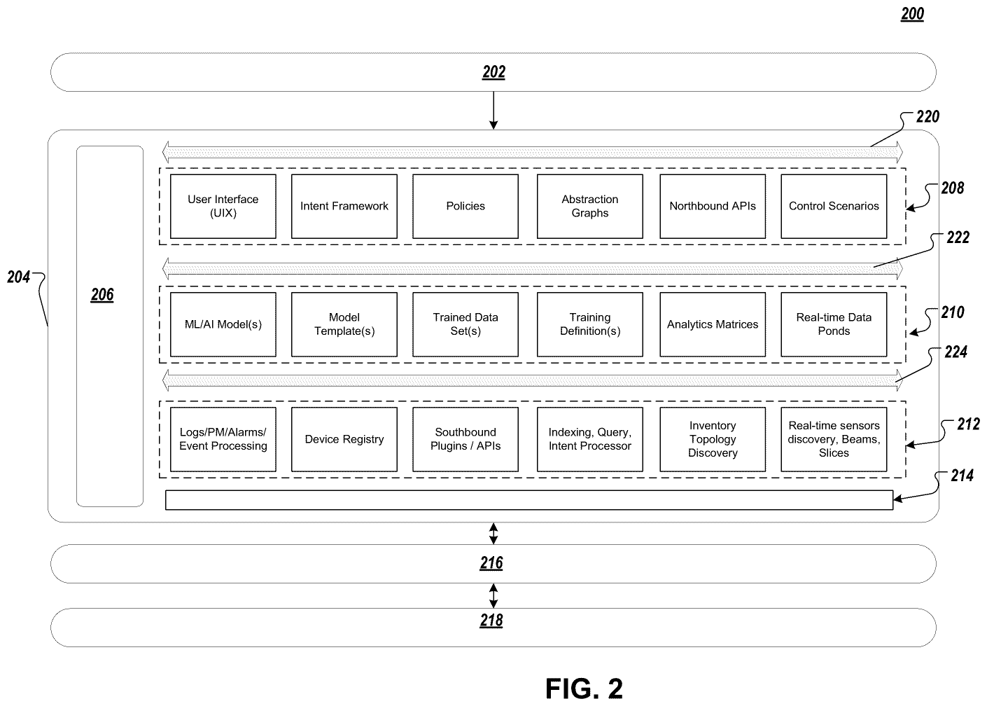

FIG. 2 shows an example of a system architecture 200 that allows for analyzing the digital twin 108 of the network environment 100 to identify relevant components that would reliably represent the operational conditions of the network environment 100 at a given time. Specifically, the architecture 200 can utilize, in some implementations, one or more trained machine learning models to identify a portion/subset of the digital twin to track the functions of the network environment 100. The system architecture 200 includes a radio digital twin (RDT) platform 204 that receives data from one or more observability applications 202. The RDT platform 204 provides data to and can receive data from a network interface 216. A target network component 218 receives and can provide data to the network interface 216. The digital twin 108, shown in FIG. 1, is generated, maintained, and configured utilizing the RDT platform 204.

In some implementations, the RDT platform 204 includes a management plane 206, a first interface layer 208, a machine learning/artificial intelligence layer (ML/AI) layer 210, a second interface layer 212, and a repository 214. The repository 214, in some implementations, includes one or more data models. The management plane 206 includes the virtual replica of the digital twin 108, and thus receives and transmits data flows 220, 222, and 224 to and from the first interface layer 208, ML/AI layer 210, and the second interface layer 212

The observability applications 202 receives data from the sensor(s) 106, shown in FIG. 1. As indicated above, the sensor(s) 106 receive information 122 from the node(s) 104, or other component in the network environment 100, and transmit information 122 to the one or more computing devices 114. The observability applications 202 monitor the information 122 output by the sensors 106, and communicate that information 122 to the RDT platform 204. In some implementations, applications can include an application (e.g., rApp) that is configured for tuning the quality of experience (QOE) for specific services on specific slices. In some implementations, the rApp monitors behavior of applications for degradation, and provides a feedback loop to optimize the QOE to make sure application on the specific slice is operating within its operating parameters.

In some implementations, the first interface layer 208 includes user interface(s), intent framework, policies, abstractions graphs, control scenarios, and one or more first application programming interfaces (APIs). The intent framework is responsible for capturing the user's intention in a higher level language. The user's intention is compiled into a set of actionable scripts or functions. For example, the user may desire, or intend, to have an end-to-end delay that is bounded for a pre-selected slice. The desired end-to-end delay (i.e., the intention) can be compiled into a set of test scripts and actionable controls that autonomously adjust the available resources to guarantee the delay bounded service.

The abstraction graph is a representation of how the physical network entities (e.g., nodes 104) are mapped to the digital twin 108 through the management plane 206. Via the abstraction graph, a vendor can control the physical network by submitting changes to the abstraction layer in the RDT platform 204. The changes submitted to the abstraction graph compiled and pushed to the appropriate targets (e.g., nodes 104) in the network environment 100. The control scenarios are a set of options that are available to vendors in order to trigger to enforce policies in the first interface layer 208.

In some implementations, the first APIs allow a lower-level network component, such as the RDT platform 204, to communicate with an upper-level component, such as a radio or cell. For example, the first APIs can be configured to facilitate communication between the sensor 106 of the node 104 and the RDT platform 204.

The ML/AI layer 210 includes ML/AI model(s), model template(s), trained data set(s), training definition(s), analytics matrices, and real-time data. The ML/AI layer 210 provides data insights about the digital twin 108, and may provide directly correlated insights about the network environment 100. For example, when appropriately trained, the ML model can be configured to output a representative set of nodes that reliably tracks network performance under a set of operating conditions.

Advantageously, the RDT platform 204, utilizing the ML/AI layer 210 can be configured to identify virtual nodes 112, performance parameters of which are representative of performance parameters of the entire network. For example, the RDT platform 204 may identify a specific node in a business district is representative of the throughput for a municipal district from noon to 3 PM. Instead of tracking data from all of the nodes 104 in the environment 100 for three hours, the RDT platform 204, implementing the digital twin 108, can identify and inform the user which virtual node(s) 112 should be monitored. The identified virtual node(s) 112 represent the corresponding specific nodes 104 in the environment 100 that should be monitored.

The second interface layer 212 includes logs, performance metrics, alarms and event processing modules/engines. The second interface layer 212 includes a device registry, an indexing module, a query module, and intent processer(s), inventory topology discovery, and real-time sensor discovery (e.g., for vendor modules, beams, and slices), and second APIs. The second APIs can be configured to perform one or more of several functions such as data collection, configuration update, monitoring and/or controlling other APIs. In some implementations, one or more of the second APIs can be configured to perform substantially similar functions as those of the first APIs.

In some implementations, the platform includes one or more software modules. For example, the device registry can be configured to track devices (e.g., user devices) in the network environment 100. The indexing module can be configured to collect incoming data from sensors 106 and catalog the data to enable the data to be searchable by pre-defined indexed categories. The inventory topology can be configured to track the components in network environment 100 and relationships between the components, e.g., relationships among nodes 104, interconnections of the nodes 104, etc.

The repository 214 can provide storage for data accumulated from one or more components of the management plane(s) 206, the first interface layer 208, the ML/AI layer 210, and the second interface layer 212. In some implementations, the repository 214 also includes data models that can be retrieved by the ML/AI layer 210 or the management plane(s) 206. The second API enables the RDT platform 204 to interface the lower-level component(s) of the system architecture 200, such as the network interface 216 and the target network component 218.

The network interface 216 can specify protocols that enable various vendors to interact with the RDT platform 204. The network interface 216, in general, enables vendors to quickly introduce their own services, or enables operators to customize the network to suit their specific requirements. As such, the network interface 216 can include one or more of open radio access network (O-RAN), Network Configuration Protocol (NETCONF), vendor-specific protocols, and embedded probes. The O-RAN can include virtualized network elements with open and standardized interfaces.

In some implementations, the target component 218 can be a network component that can be controlled using a control signal generated by the RDT platform. For example, once the RDT platform identifies a particular target component 218 as the root cause of an anomaly (e.g., by analyzing a representative subset of the digital twin), the RDT platform can generate a control signal to address the anomaly at the target network component 218. In some implementation, the target network component 218 can be configured to exchange information with the RDT platform via one or more plugins and/or APIs of the second interface layer. In some implementations, when a user submits an update to the digital twin 108, a control signal can be generated to affect one or more corresponding physical resources (e.g., the node 104) and also reflected in the digital twin 108.

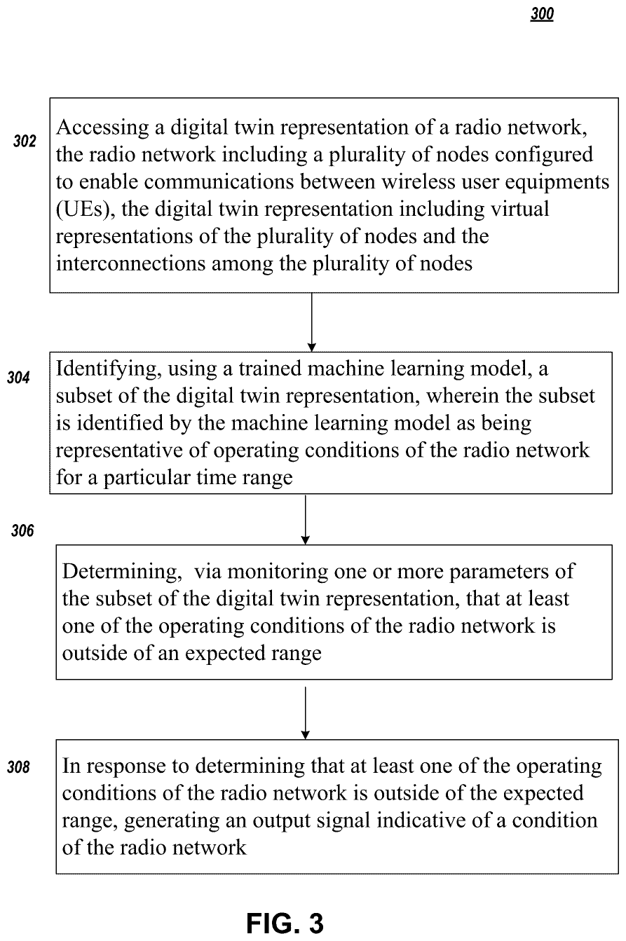

FIG. 3 is a flowchart of an example process 300 for implementing the technology described with reference to FIGS. 1-2. The process 300 can be executed, for example, by a system of one or more computers, located in one or more locations, and programmed appropriately in accordance with the technology described in this specification. For example, the process 300 may be executed, at least in part, by one or more computing devices associated with the system architecture 200 of FIG. 2.

The process 300 includes accessing, via a one or more processing devices, a digital twin representation (DTR) of a radio network (302). For example, the digital twin 108 can be accessed at operation 302. The plurality of nodes are configured to enable communications between wireless user equipments (UEs). The DTR can include virtual representations of the plurality of nodes and the interconnections among the plurality of nodes. For example, the digital twin 108 can be a virtual representation of the network environment 100.

The process 300 also includes identifying, using a trained machine learning model, a subset of the DTR (304). The subset of the DTR is identified by the machine learning model as representative of operating conditions of the radio network for a particular time range. For example, operating conditions can be in terms of any metric that is output by the node(s) 104, interconnect, or other network component of the network environment 100. The length of a particular time range is determined by a user, which can be in a range from a few milliseconds to minutes, hours, days, weeks, or months.

The process 300 further includes determining, by the one or more processing devices via monitoring one or more parameters of the subset of the DTR, that at least one of the operating conditions of the radio network is outside of an expected range (306). The parameters can include number of beams, slices, a time of day, usage of private and or public slices, radio power level, RF characteristics, and the like. In some implementations, the parameters of the subset of the DTR can be monitored by the RDT platform 204. In some implementations, the ML/AI layer 210 can determine which parameters correlate to overall conditions of the environment 100 for the particular time range.

In another example, an expected range can be a range of any of the nodes or interconnects on the network environment 100. For example, the RDT platform 204 can detect data anomalies, outliers, and irregular behavior on the network environment 100, which is reflected in the digital twin 108.

The process 300 also includes generating an output signal indicative of a condition of the radio network. For example, at operation 308, in response to determining that at least one of the operating conditions of the radio network is outside of the expected range, an output signal can be generated. The output signal can indicate a condition of the RN, such as

One advantage of the process 300 described herein is that, in lieu of requiring an operator or vendor to address each actual alarm, the system architecture 200 enables the identification of a route cause of an anomaly, outliers, irregular behavior on the network environment 100, via the digital twin 108. A user can make changes to address the problem on the digital twin 108, and those changes later be adopted in the actual network environment 100.

In some implementations, the process 300 can be implemented to reduce operational data manual scanning and anomaly detection. The process 300 can provide a health check of all network components including nodes, cell sites, pods, clusters, and links through proactive measurements and testing of “corner cases,” i.e., network components that are representative of a network environment or pre-defined portion thereof.

In some implementations, the process 300 can implemented to control the dynamics and conditions for optimal abnormality observability. For example, the process 300 can be utilized to quickly identify, using similarity checks, abnormal behaviors in the network environment. In another example, the process 300 is measures key performance indicators (KPIs) and identifies abnormalities when compared to other KPIs utilizing their matrix representations.

In yet another implementation, the process 300 can be used to gather sensory and traffic statistics from all user devices that represent the digital twin behavior of the particular user devices and collective representation of a given network services. For example, the process 300 can be used to identify network behavior, metrics at specified interfaces, and configuration ranges that represent digital twin of a node (e.g., cell site) in the network environment. In another example, the digital twin utilizes graphical and color coded heat map representations to represent network behavior, alarms, and anomalies.

In yet another implementation, the process 300 enables reactive and proactive testing and root cause diagnosis. For example, the end user(s) can program the digital twin to change behaviors in real-time. A virtual representation of cell site digital twin can be programmed to emulate behaviors and find optimal settings before the updates are pushed to the target nodes in the network environment. In another example, the process 300 reflects the digital twin representations of a given node (e.g., cell sites) and vectors stemming from the given node.

In another implementation, the process 300 can be implemented to identify RAN abnormalities and optimization practices. In one example, end user (e.g., a service provider) utilizes rule-based parameter optimization and automation that are based on collective abnormality measures of multiple nodes (e.g., cell sites).

In yet another implementation, the process 300 monitors KPIs and network trends. For instance, the digital twin representation of specific node (e.g., cell sites) provide trends from historical data received from the network environment.

In yet another implementation, the process 300 can be implemented to perform real time queries in the digital twin against the current network environment behaviors with no/low impact on the network resources. For instance, the process 300 can be utilized to provide on-demand measurement of network behavior from the abstracted digital twins that are not impacting the target node for multiple hits. In one example, by when a user submits changes or submits a request for observability at the abstraction layer, the RDT platform 204 may prohibit multiple users from submitting changes to a same target node, and therefore causing multiple hits. The results of the submitted change can be cached and the RDT platform 204 can be configured to enable the results to be shared with multiple users. In this manner, the RDT platform 204 can be configured to prevent multiple “hits” (e.g., substantially simultaneous updates) to the same target.

In another implementation, the process 300 monitors relevant logs, metrics and traces, enabling the end user to understand a user-specified event across platforms. Accordingly, the end user can provide queries to the RDT platform and receive answers relate to the user-specified event(s). For example, an end-user can request and receive specific insights from a user-specified node, such as a cell site. The specific insight can involve requesting for knowledge or understanding of the big picture of a target, e.g., a specific cell site. When a user wants to retrieve an insight for a specific cell ID or cell site, the user may submit a request for a specified number of KPIs that represent a behavior of the specific cell ID or cell site.

In some implementation, the process 300 enables indexing of KPIs, log files, traps and alerts, and configurations for emerging observability applications. In at least one example, the ML/AI layer enables the RDT platform indexing. In another example, the RDT platform enables indexing and measurement of sensor data, which provides search capability for the end user and/or first and second APIs without directly impacting the target node in the network environment.

In yet another implementation, the process 300 provides visibility for a performance of the overall RAN system with security, scalability, and abstraction. For example, the process 300 allows for the discovery of changes to the physical network environment and represents the updates to the one or more digital twin representations. In another example, the process 300 enables initialized nodes (e.g., cell sites) the capability to discover expected inventory and configuration to representations of the actual behaviors. In some implementations, the user may desire a holistic view of the network environment 100 or a portion thereof, such as a multiple cell sites, a region, or a particular service area. By providing access to these insight through the RDT platform, the end user does not have to log in to the target devices, radios. In this manner, security risks are minimized in the network environment. The RDT platform is scalable and can thus provide multi-dimensional knowledge about multiple target devices, at the same time.

In some implementation, the process 300 facilities Slice service level agreement (SLA) management and optimization. In one example, the process 300 enables the RDT platform to monitor abstraction of slice representation and usage.

In other implementations, the process 300 monitor the impact of beam formation at a given node(s) and provides feedback to the end user. For example, the platform monitors “corner cases” of beam patterns and creates graphical representations in the database with vector embedding.

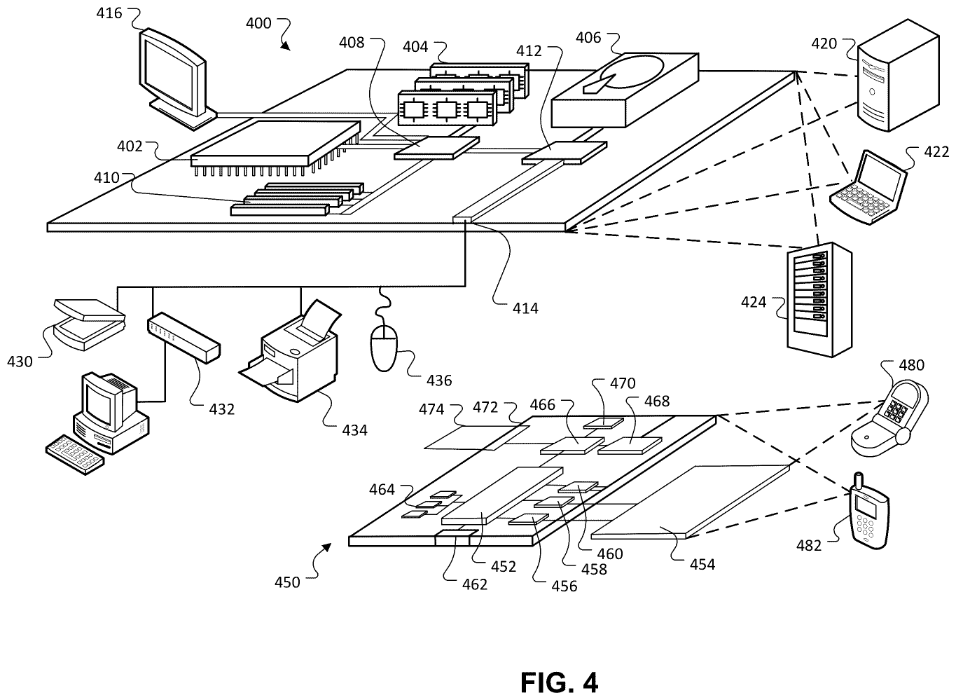

FIG. 4 shows an example of a computing device 400 and a mobile computing device 450 that are employed to execute implementations of the present disclosure. The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting. The computing device 400 and/or the mobile computing device 450 can form at least a portion of the network environments (e.g., environment 100) described above. The computing device 400 and/or the mobile computing device 450 can also form at least a portion of the one or more computing devices 114 described above. In some implementations, the network functions and/or network entities described above can be implemented using a cloud infrastructure including multiple computing devices 400 and/or mobile computing devices 450.

The computing device 400 includes a processor 402, a memory 404, a storage device 406, a high-speed interface 408, and a low-speed interface 412. In some implementations, the high-speed interface 408 connects to the memory 404 and multiple high-speed expansion ports 410. In some implementations, the low-speed interface 412 connects to a low-speed expansion port 414 and the storage device 404. Each of the processor 402, the memory 404, the storage device 406, the high-speed interface 408, the high-speed expansion ports 410, and the low-speed interface 412, are interconnected using various buses, and may be mounted on a common motherboard or in other manners as appropriate. The processor 402 can process instructions for execution within the computing device 400, including instructions stored in the memory 404 and/or on the storage device 406 to display graphical information for a graphical user interface (GUI) on an external input/output device, such as a display 416 coupled to the high-speed interface 408. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of a computer-readable medium, such as a magnetic or optical disk.

The storage device 406 is capable of providing mass storage for the computing device 400. In some implementations, the storage device 406 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 402, perform one or more methods, such as those described above. The instructions can also be stored by one or more storage devices, such as computer-readable or machine-readable mediums, such as the memory 404, the storage device 406, or memory on the processor 402.

The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards. In the implementation, the low-speed interface 412 is coupled to the storage device 406 and the low-speed expansion port 414. The low-speed expansion port 414, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 414 through a network adapter. Such network input/output devices may include, for example, a switch or router.

The computing device 400 may be implemented in a number of different forms, as shown in the FIG. 4. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device, such as a mobile computing device 450. Each of such devices may contain one or more of the computing device 400 and the mobile computing device 450, and an entire system may be made up of multiple computing devices communicating with each other.

The mobile computing device 450 includes a processor 452; a memory 464; an input/output device, such as a display 454; a communication interface 466; and a transceiver 468; among other components. The mobile computing device 450 may also be provided with a storage device, such as a micro-drive or other device, to provide additional storage. Each of the processor 452, the memory 464, the display 454, the communication interface 666, and the transceiver 468, are interconnected using various buses, and several of the components may be mounted on a common motherboard or in other manners as appropriate. In some implementations, the mobile computing device 450 may include a camera device(s).

The processor 452 can execute instructions within the mobile computing device 450, including instructions stored in the memory 464. The processor 452 may be implemented as a chipset of chips that include separate and multiple analog and digital processors. For example, the processor 452 may be a Complex Instruction Set Computers (CISC) processor, a Reduced Instruction Set Computer (RISC) processor, or a Minimal Instruction Set Computer (MISC) processor. The processor 452 may provide, for example, for coordination of the other components of the mobile computing device 450, such as control of user interfaces (UIs), applications run by the mobile computing device 450, and/or wireless communication by the mobile computing device 450.

The processor 452 may communicate with a user through a control interface 458 and a display interface 456 coupled to the display 454. The display 454 may be, for example, a Thin-Film-Transistor Liquid Crystal Display (TFT) display, an Organic Light Emitting Diode (OLED) display, or other appropriate display technology. The display interface 456 may include appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a Single in Line Memory Module (SIMM) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provided as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 452, perform one or more methods, such as those described above. The instructions can also be stored by one or more storage devices, such as one or more computer-readable or machine-readable mediums, such as the memory 464, the expansion memory 474, or memory on the processor 452. In some implementations, the instructions can be received in a propagated signal, such as, over the transceiver 468 or the external interface 462.

The mobile computing device 450 may communicate wirelessly through the communication interface 666, which may include digital signal processing circuitry where necessary. The communication interface 666 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS), IP Multimedia Subsystem (IMS) technologies, and 5G technologies. Such communication may occur, for example, through the transceiver 468 using a radio frequency. In addition, short-range communication, such as using a Bluetooth or Wi-Fi, may occur. In addition, a Global Positioning System (GPS) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, etc.) and may also include sound generated by applications operating on the mobile computing device 450.

The mobile computing device 450 may be implemented in a number of different forms, as shown in FIG. 4. For example, it may be implemented in the UE described with respect to FIG. 1. Other implementations may include a phone device 480, a personal digital assistant 482, and a tablet device (not shown). The mobile computing device 450 may also be implemented as a component of a smart-phone, AR device, or other similar mobile device.

The computing device 400 may be implemented in the network environment 100 described above with respect to FIGS. 1-3. Computing device 400 and/or 450 can also include USB flash drives. The USB flash drives may store operating systems and other applications. The USB flash drives can include input/output components, such as a wireless transmitter or USB connector that may be inserted into a USB port of another computing device.

Disclosed herein is a digital twin of a radio network environment that is configured to predict anomalies in the radio network environment. Other embodiments and applications not specifically described herein are also within the scope of the following claims. Elements of different implementations described herein may be combined to form other embodiments.

1. A method comprising:
accessing, by a one or more processing devices, a digital twin representation of a radio network (RN), the radio network including a plurality of nodes configured to enable communications between wireless user equipments (UEs), the digital twin representation including virtual representations of the plurality of nodes and interconnections among the plurality of nodes;
identifying, using a trained machine learning model, a first subset of the digital twin representation, wherein the first subset is identified by the machine learning model as being representative of operating conditions of the radio network for a first time range;
determining, by the one or more processing devices via monitoring one or more parameters of the first subset of the digital twin representation, that at least one of the operating conditions of the radio network is outside of a corresponding expected range; and
in response to determining that at least one of the operating conditions of the radio network is outside of the corresponding expected range, generating a first output signal indicative of a condition of the radio network during the first time range.

2.-3. (canceled)

4. The method of claim 1, further comprising:
identifying, using the trained machine learning model, a second subset of the digital twin representation, wherein the second subset is representative of operating conditions of the radio network for a second time range different from the first time range.

5. The method of claim 4, wherein the second subset is different from the first subset.

6. The method of claim 4, further comprising:
determining, by the one or more processing devices via monitoring one or more parameters of the second subset of the digital twin representation, that at least one of the operating conditions of the radio network is outside of a corresponding expected range; and
in response to determining that at least one of the operating conditions of the radio network is outside of the corresponding expected range, generating a second output signal indicative of a condition of the radio network during the second time range.

7. The method of claim 1, further comprising generating a control signal configured to address the at least one condition of the operating conditions of the radio network.

8. The method of claim 1, further comprising:
identifying, from the first subset of the digital twin representation, one or more nodes as a root cause of the at least one of the operating conditions of the radio network being outside of the corresponding expected range; and
generate the control signal such that the control signal is configured to affect operations of the one or more nodes.

9. The method of claim 1, wherein the one or more parameters comprise at least one of: a number of beams, a number of slices, a radio power level, or RF characteristics.

10. The method of claim 1, wherein the one or more parameters are determined by the machine learning model.

11. One or more non-transitory computer storage media encoded with computer program instructions that when executed by one or more computers cause the one or more computers to perform operations comprising:
accessing a digital twin representation of a radio network, the radio network including a plurality of nodes configured to enable communications between wireless user equipments (UEs), the digital twin representation including virtual representations of the plurality of nodes and the interconnections among the plurality of nodes;
identifying a first subset of the digital twin representation, wherein the first subset is identified by the machine learning model as being representative of operating conditions of the radio network for a first time range;
determining via monitoring one or more parameters of the first subset of the digital twin representation, that at least one of the operating conditions of the radio network is outside of a corresponding expected range; and
in response to determining that at least one of the operating conditions of the radio network is outside of the corresponding expected range, generating an output signal indicative of a condition of the radio network during the first time range.

12. The one or more non-transitory computer storage media of claim 11, the operations further comprising:
identifying, using the trained machine learning model, a second subset of the digital twin representation, wherein the second subset is representative of operating conditions of the radio network for a second time range different from the first time range.

13. The one or more non-transitory computer storage media of claim 12, wherein the second subset is different from the first subset.

14. The one or more non-transitory computer storage media of claim 12, further comprising:
determining, via monitoring one or more parameters of the second subset of the digital twin representation, that at least one of the operating conditions of the radio network is outside of a corresponding expected range; and
in response to determining that at least one of the operating conditions of the radio network is outside of the corresponding expected range, generating a second output signal indicative of a condition of the radio network during the second time range.

15. The one or more non-transitory computer storage media of claim 11, further comprising generating a control signal configured to address the at least one condition of the operating conditions of the radio network.

16. The one or more non-transitory computer storage media of claim 11, further comprising:
identifying, from the first subset of the digital twin representation, one or more nodes as a root cause of the at least one of the operating conditions of the radio network being outside of the corresponding expected range; and
generate the control signal such that the control signal is configured to affect operations of the one or more nodes.

17. The one or more non-transitory computer storage media of claim 11, wherein the one or more parameters comprise at least one of: a number of beams, a number of slices, a radio power level, or RF characteristics.

18. The one or more non-transitory computer storage media of claim 11, wherein the one or more parameters are determined by the machine learning model.

19. A system comprising: one or more computers and one or more storage devices on which are stored instructions that are operable, when executed by the one or more computers, to cause the one or more computers to perform operations comprising:
accessing a digital twin representation of a radio network, the radio network including a plurality of nodes configured to enable communications between wireless user equipments (UEs), the digital twin representation including virtual representations of the plurality of nodes and the interconnections among the plurality of nodes;
identifying a first subset of the digital twin representation, wherein the first subset is identified by the machine learning model as being representative of operating conditions of the radio network for a first time range;
determining, via monitoring one or more parameters of the first subset of the digital twin representation, that at least one of the operating conditions of the radio network is outside of a corresponding expected range; and
in response to determining that at least one of the operating conditions of the radio network is outside of the corresponding expected range, generating an output signal indicative of a condition of the radio network during the first time range.

14. The system of claim 19, further comprising:
identifying, using the trained machine learning model, a second subset of the digital twin representation, wherein the second subset is representative of operating conditions of the radio network for a second time range different from the first time range.

21. The system of claim 20, further comprising:
determining, by the one or more processing devices via monitoring one or more parameters of the second subset of the digital twin representation, that at least one of the operating conditions of the radio network is outside of a corresponding expected range; and
in response to determining that at least one of the operating conditions of the radio network is outside of the corresponding expected range, generating a second output signal indicative of a condition of the radio network during the second time range.

22. The method of claim 1, further comprising generating a control signal configured to address the at least one condition of the operating conditions of the radio network.
